(19) United States
(12) Patent Application Publication
(10) Pub. No.: US 2025/0314492 A1
(43) Pub. Date: Oct. 9, 2025

(54) EARLY WARNING METHOD FOR DEBRIS FLOW DISASTER IN SMALL WATERSHED, AND DISASTER REDUCTION METHOD FOR DEBRIS FLOWS IN SMALL WATERSHED

(71) Applicant: Zhejiang University, Zhoushan (CN)

(72) Inventors: Hongyue Sun, Zhoushan (CN); Xu Wang, Zhoushan (CN); Yang Yu, Zhoushan (CN); Wei Ge, Zhoushan (CN); Renjie Tang, Zhoushan (CN); Keying Zhang, Zhoushan (CN); Tianxing Ma, Zhoushan (CN); Hao Chen, Zhoushan (CN); Rui Luo, Zhoushan (CN); Tianlong Wang, Zhoushan (CN)

(21) Appl. No.: 18/642,865

(22) Filed: Apr. 23, 2024

(30) Foreign Application Priority Data
Apr. 9, 2024 (CN) 202410423939.2

(51) Int. Cl. G01C 13/00; G01W 1/14

(52) U.S. Cl. CPC G01C 13/00; G01W 1/14

(57) ABSTRACT

An early warning method for debris flow disaster in a small watershed, and a disaster reduction method for debris flows in a small watershed is disclosed. An early warning method for debris flow disaster in a small watershed is provided, in which parameters of a hydrological model are calibrated by rainfall, evaporation and runoff data of the watershed based on water balance of the watershed, and an early monitoring and warning scheme for debris flows, which takes water storage in the watershed as a core monitoring and evaluation indicator, is established. The GR4J hydrological model is improved by taking into account a watershed area, specific yield of an aquifer and several geological parameters, as well as an evapotranspiration effect of vegetation. A disaster reduction method by means of regulation of a drainage channel can provide a basis for mathematical model simulation studies of disaster reduction in small watersheds.

### CROSS REFERENCE TO RELATED APPLICATIONS

The present application claims the benefit of Chinese Patent Application No. 202410423939.2 filed on Apr. 9, 2024, the contents of which are incorporated herein by reference in their entirety.

### TECHNICAL FIELD

The present invention belongs to the technical field of geo-environmental monitoring, geo-hazard prevention and control as well as monitoring and early warning, and relates to a prevention and control technology for debris flow disaster, in particular to an early warning method and system for debris flow disaster in a small watershed.

### BACKGROUND

With regard to sudden and rapid surface runoff caused by rainfall in small watersheds in hilly areas, due to small area and short gullies of small watersheds, and the surface runoff often converging in relatively narrow gully channels and some periodically waste watercourses, surface convergence has a short period of time and often shows the characteristics of surge and collapse. Strong hydrodynamic conditions can be generated in gullies in a short period of high-intensity rainfall, and loose deposits are susceptible to debris flows when subjected to large scouring forces. Debris flows in small watersheds are characterized by high number and wide coverage, which are closely related to local landslides on water-saturated slopes, and are characterized by hidden locations and rapid disaster, resulting in the difficulty to avoid successfully after the occurrence of disaster. On the whole, geological disaster caused by precipitation in small watersheds is numerous and widespread, and has obvious multiplicity, disorganized suddenness and intense destructiveness, resulting in difficult defense. In the current idea of prevention and control of geological disaster in mountain environment, focused management taking small watersheds as a unit has become a major scheme.

Since debris flow disaster in small watersheds depends primarily on precipitation, and the process of its runoff and confluence movements is a physical process that can be simulated by a hydrological process, obtaining the depth of runoff and the amount of runoff in different recurrence periods and under different probabilities of rainfall in spatial locations of small watersheds by applying a hydrological model to simulate the hydrological process of small watersheds can provide effective technical support for the monitoring and early warning for debris flow disaster in small watersheds. However, there is a lack of such technical schemes in the prior art.

The prior art “Research on Debris Flow Risk Assessment and Early Warning and Disaster Reduction System in Earthquake Areas” (Xia Tian, Chengdu University of Technology, 2013) provides a technical scheme to introduce a hydrological model into debris flow monitoring and early warning. The main technical defect of this scheme lies in that although the high-precision DEM and hydrological model are used to extract catchment units according to different catchment thresholds as inputs for debris flow monitoring and analysis, in the dynamic analysis of debris flow formation in a study area, insufficient consideration has been given to the characteristics of stratum “catchment” and its dynamic changes in the area, and the characteristics of catchment and storage in the area have not been taken as analytical elements for dynamic monitoring of debris flows, so that an precipitation indicator can only be selected retrospectively as a threshold indicator for debris flow monitoring. Due to the complexity of the rainfall process, many factors such as the intensity of a single rainfall, changes in the rainfall intensity process, rainfall persistence and an interval time will affect the distribution of rainfall infiltration and surface runoff, thus there is no linear relationship between the rainfall process and changes in the saturation of slopes. Meanwhile, constrained by uncertainty in the rainfall process, the forecasting accuracy is low. As a result, there is an insurmountable upper limit to the accuracy of debris flow disaster forecasting based on rainfall monitoring data.

### SUMMARY

The object of the present invention is to provide, aiming at the shortcomings in the prior art, a monitoring and early warning technology for debris flow disaster in a small watershed, in which catchment and storage characteristics of surface strata of small watersheds as monitoring threshold indicators. Meanwhile, a disaster reduction method for debris flows in a small watershed based on the monitoring and early warning technology is provided.

To achieve the above object, the present invention first provides an early warning method for debris flow disaster in a small watershed, and its technical scheme is as follows.

An early warning method for debris flow disaster in a small watershed, including:
step S100, monitoring field survey of a target watershed to acquire basic data of the target watershed, the basic data including topographic and hydrological data used to build a hydrological model; and deploying monitoring devices to collect real-time environmental monitoring data, the environmental monitoring data including evaporation, rainfall, and runoff data;
step S200, constructing a GR4J hydrological model of the target watershed using the basic data of the target watershed, and constructing, using the GR4J hydrological model, a water storage S model of the target watershed that is expressed by Equation 1-1,

$$S = {S}_{1} + {S}_{2} \qquad Equation 1 - 1$$

in the Equation, S₁ and S₂ are the water storage of a runoff producing reservoir and the water storage of a confluence reservoir in the GR4J hydrological model, respectively, in mm;
step S300, based on the real-time environmental monitoring data, acquiring initial water storage Sᵢₙₜ in the target watershed using the water storage S model;
step S400, measuring the maximum water storage Sₘₐₓ for runoff-induced debris flows in the target watershed using the water storage S model of the target watershed,

$${S}_{max} = {S}_{int} + Y - Z - L + {R}_{i o} \qquad Equation 2$$

$$L = 4. 0 b {M}^{1.5} / tan {θ}^{1.17} \qquad Equation 3$$

in the Equations, Sₘₐₓ is the maximum water storage for runoff-induced debris flows in the target watershed,
Sᵢₙₜ is the initial water storage in the target watershed in mm, determined in step S300,
Y is the precipitation over the watershed in the GR4J hydrological model,
Z is the evaporation over the watershed in the GR4J hydrological model,
Rᵢₒ is the water exchange between groundwater and the watershed in the GR4J hydrological model,
L is the minimum debris flow initiation critical flow in a main channel of the target watershed, in m³/s,
b is the width of the main channel of the target watershed, in m, determined according to the basis data,
M is the average particle size of trench bed debris, in mm, determined according to the basis data, and
θ is the slope of the main channel of the target watershed, in °, determined according to the basis data;
step S500, measuring dynamic update values S′₁ and S′₂ of S₁ and S₂, as well as real-time water storage S(t) in the target watershed by taking rainfall data as an input to the water storage S model,

$$S ( t ) = {S}_{1}^{′} + {S}_{2}^{′} \qquad Equation 1 - 2$$

step S600, measuring a debris flow early warning value K for the target watershed, and evaluating debris flow early warning content in the target watershed according to the value K,

$$K = S ( t ) / {S}_{max} \qquad Equation 4$$

in the Equation, K is the debris flow early warning value for the target watershed.

The basic idea of the above early warning method for debris flow disaster in a small watershed of the present invention is to establish an input/output balance model for water quantity of the target watershed based on the theory of water balance of small watersheds, and then to take the water storage S in the target watershed as a key dynamic observation variable for monitoring and early warning of debris flows and to take same as a monitoring threshold indicator, so as to change the traditional thinking in the prior art that takes the precipitation indicator as the monitoring threshold indicator. To realize the above technical concept, in the method of the present invention, a GR4J hydrological model calibrated by rainfall, evaporation and runoff data of the watershed is first established, and a water storage S model of the target watershed is further established, so as to directly reflect the water storage in the target watershed as a dynamic change in water and soil environment elements, which water storage thus becomes an effective monitoring indicator for debris flow monitoring and early warning. To provide scientific and reasonable threshold conditions for monitoring indicators, the water storage S model of the watershed is combined with a calculation model of the minimum debris flow initiation critical flow L of the main channel of the small watershed in the present invention to solve the problem of calculating the maximum water storage Sₘₐₓ for runoff-induced debris flows in the target watershed. Finally, a value K is used to visualize the degree of debris flow risk in the target watershed. Accordingly, a complete set of monitoring and early warning technical scheme for debris flow disaster by taking the water storage in the target watershed as a monitoring and evaluation indicator is established.

The present invention further provides an improved GR4J hydrological model, so as to optimize the above early warning method for debris flow disaster in a small watershed. The improved GR4J hydrological model includes two contents that are not necessarily implemented simultaneously or sequentially.

In the improved GR4J hydrological model, the dynamic update values S′₁ and S′₂ of S₁ and S₂ are measured respectively according to Equation 5-1 and Equation 5-2.

$${S}_{1}^{′} = ( {S}_{1} - {Z}_{s} + {Y}_{s} ) A β tan i \qquad Equation 5 - 1$$

$${S}_{2}^{′} = ( {S}_{2} - R ) A tan η \qquad Equation 5 - 2$$

In the Equations, Zₛ is the evapotranspiration of the runoff producing reservoir in the GR4J hydrological model,
Yₛ is the precipitation for replenishment of the runoff producing reservoir in the GR4J hydrological model,
A is the area of the target watershed, in m², determined according to the basis data,
i is the average inclination of slopes in the target watershed, in °, determined according to the basis data;
β is the average specific yield of the aquifer in the target watershed, determined according to the basis data,

R is the intermediate amount of the water storage of the confluence reservoir in the GR4J hydrological model, and
η is the inclination of the main channel of the target watershed, in °, determined according to the basis data of the target watershed.

In the improved GR4J hydrological model, the evapotranspiration Zₛ of the runoff producing reservoir is expressed by Equation 6.

$${Z}_{s} = \frac{{S}_{1} ( 2 - \frac{{S}_{1}}{{w}_{1}} ) tanh ( \frac{{Z}_{n}}{{w}_{1}} )}{1 + ( 1 - \frac{{S}_{1}}{{w}_{1}} ) tanh ( \frac{{Z}_{n}}{{w}_{1}} )} ψ \qquad Equation 6$$

In the Equation, w₁ is the water storage of the runoff producing reservoir in the GR4J hydrological model, in mm,
Zₙ is the residual evapotranspiration capacity in the GR4J hydrological model, in mm, and
ψ is a vegetation evaporation factor of the target watershed, determined according to the basis data.

In addition to optimizing the above basic technical scheme by improving the GR4J hydrological model, the optimization of the above early warning method for debris flow disaster in a small watershed of the present invention also includes the following schemes.

In the step S400, the basic data of the target watershed is substituted into the water storage S model to measure the initial water storage Sᵢₙₜ in the target watershed.

In the step S400, Sᵢₙₜ is the water storage in the watershed that is obtained by training the GR4J model with time-series monitoring data.

In the step S500, the rainfall data input into the water storage S model are forecast rainfall data or real-time monitoring watershed hydrological update data.

The present invention also provides a specific scheme for evaluating early warning content of debris flows in the target watershed according to the value K, including: K≥0.98 indicating a red early warning, 0.98>K≥0.95 indicating an orange early warning, and 0.95>K≥0.90 indicating a blue early warning.

By using the early warning method for debris flow disaster in a small watershed of the present invention, the value of dynamic changes in water quantity in small watersheds in the prevention and control of debris flows in small watersheds is enhanced by solving the problems of real-time water storage in a target watershed and the measurement of evaluation thresholds that match the water storage. As a result, a quantifiable and scientifically evaluated disaster reduction scheme can be established by manually increasing the water output of the target watershed during disaster prevention and control. Based on this, another object of the present invention is to provide a disaster reduction method for debris flows in a small watershed as follows.

A disaster reduction method for debris flows in a small watershed, which is implemented using the above early warning method for debris flow disaster in a small watershed, includes: adding an artificial drainage measure in a target watershed, diverting the runoff in the target watershed by using the artificial drainage measure, accelerating the release of the water storage in the target watershed, acquiring S(t) for regulation of a drainage channel according to Equation 7, and not performing step S600 after step S500,

$${S}_{a d} ( t ) = S ( t ) - T Q ( t ) / A \qquad Equation 7$$

in the Equation, S_{ad}(t) is S(t) for regulation of the artificial drainage measure, in mm,
Q(t) is the real-time diversion of water of the artificial drainage measure, in m³/s,
A is the area of the target watershed, in m², determined according to the basis data, and
T is the diverting time of the artificial drainage measure, in s, determined according to monitoring data.

In the above disaster reduction method for debris flows in a small watershed, the runoff in a target watershed is diverted by using an artificial drainage measure, and the release of the water storage in the target watershed is accelerated, thereby increasing the disaster tolerance capacity of the target watershed, increasing the critical water storage, and reducing the current water storage in the watershed. Artificial drainage measures, such as biological management and increased afforestation, can increase the transpiration and evaporation capacity of plants, thereby increasing the critical water storage. For another example, drainage setups such as artificial drainage channels, slope drainage, and internal drainage of slopes within the main channel of the watershed can all have the effect of reducing the water storage in the watershed.

The present invention further provides a disaster reduction method using a drainage channel for regulation. Specifically, the artificial drainage measure is to construct a drainage channel with a V-shaped bottom, an inlet of the drainage channel is arranged in the area, where loose deposits are concentrated, upstream of the main channel of the small watershed, and an outlet is arranged away from the area where loose deposits are distributed. Q(t) is the real-time diversion of water of the drainage channel, and is measured according to Equation 8.

$$Q ( t ) = {{\frac{1}{n} [ \frac{h ( t )}{tan α} ]}^{5 / 3} [ \frac{2 h ( t )}{sin α} ]}^{- 2 / 3} {J}^{1 / 2} \qquad Equation 8$$

In the Equation, n is a roughness coefficient of the drainage channel, determined according to structural parameters of the drainage channel,
J is the hydraulic gradient of the drainage channel, in %, determined according to structural parameters of the drainage channel,
h(t) is a real-time water level elevation in the drainage channel, in m, collected by a monitoring device in real time, and
α is the inclination of a triangular cross-section of the drainage channel, in °, determined according to structural parameters of the drainage channel.

By means of the above disaster reduction method using a drainage channel for regulation, the design of structural parameters of the drainage channel can be accomplished using an inverse approach. Specifically, a disaster reduction design objective for debris flows is first determined, which objective may be a relationship between S_{ad}(t) and S(t), or may be a relationship between values K respectively expressed by S_{ad}(t) and S(t), and then inverse calculations are performed using Equation 7 and Equation 8 to complete the design of structural parameters of the drainage channel. The structural parameters include α or n or J.

The field investigation referred to in this art includes all kinds of geological surveys, reconnaissance, mapping and measuring work for the site of small mudflow channels where the planned scheme aims to; simulation experiments, test experiments, observation experiments, and analysis experiments in the field; acquisition of historical records of disaster; the relevant technical specifications; and the acquisition of empirical methods and data that are useful for reference and reference, etc. The data acquired from on-site surveys are collectively referred to as the basic data of this technical scheme.

Compared with the prior art, the beneficial effects of the present invention are: (1) although the existing research recognizes that precipitation-induced changes in surface runoff and confluence and water content and storage of soil in small watersheds are primary triggers of debris flow disaster in small watersheds, it can only fall back on the choice of precipitation indicators in watersheds as monitoring and evaluation indicators in the hydrological model-based debris flow monitoring and early warning technical scheme since the technical problem of using the water storage in small watersheds as monitoring and evaluation indicators for debris flow disaster cannot be solved in the prior art. This kind of technical scheme is inevitably constrained by the uncertainty of a rainfall process. In the present invention, parameters of a hydrological model are calibrated by rainfall, evaporation and runoff data of a watershed based on the theory of water balance of the watershed, and the water storage data of the watershed are calculated in real time. Disaster monitoring and early warning are then realized by taking water storage in the watershed as an evaluation indicator, meteorological data as input parameters, and the debris flow initiation critical flow of the watershed as a benchmark. The water balance of small watersheds is defined as the input water (i.e., incoming water) minus the output water (i.e., outgoing water) to a watershed, region, or body of water at any point in time (e.g., hourly, daily, monthly, yearly, etc.) equaling the water storage variable of the range. From the water balance, the realization of monitoring and early warning for debris flows in small watersheds is a brand new technical concept of the present invention, which is different from the prior art. (2) In the technical schemes of the present invention, water storage S in watersheds is a key indicator, including the buried depth of the water table and the water content of the rock and soil mass above the water table line, as well as the total runoff water of channels in watersheds, and thus can be used to measure the cumulative degree of rainfall infiltration in watersheds. This indicator reflects the saturated state of slopes and the degree of susceptibility to geologic disaster, and the higher the value, the higher the degree of saturation of slopes and the higher the possibility of geological disaster induced by rainfall in the future. Compared with the indicator of precipitation in small watersheds, the indicator of water storage in small watersheds reflects the changes in soil and water conditions in small watersheds more intuitively, so that it is targeted to overcome the technical shortcomings in the prior art in the selection of monitoring indicators, and has a more scientific principle of monitoring and early warning for debris flow disaster. Meanwhile, the monitoring and early warning based on the water storage in watersheds can show the risk of debris flow disaster before the occurrence of water-soil coupling changes in the area, so that it is a more effective and direct early warning scheme. (3) To optimize the water storage S model of a small watershed of the present invention, the present invention provides an improved GR4J hydrological model. The improved GR4J model takes into account geological parameters such as a watershed area, specific yield of an aquifer, and an inclination angle of a watershed slope and a main channel in the water storage change formula of the watershed, and takes the vegetation type influencing factor into an evapotranspiration formula of the watershed. The inclusion of geologic parameters of the watershed facilitates the investigation of the effects of changes in different watershed sizes, geologic conditions of the aquifer, slope inclination in the watershed, vegetations in the watershed, and other parameters on the changes in critical water storage in the watershed. (4) Based on the principle of water balance of small watersheds, as long as the water output of small watersheds is increased, i.e., the drainage of small watersheds to the outside of the watersheds is promoted, the disaster tolerance capacity of watersheds can be improved, the critical water storage can be increased, and the current water storage in watersheds can be reduced, so as to slow down or even prevent the occurrence of debris flow disaster. Although this technical idea is scientific and reasonable, and the means of realization is simple and easy to implement, however, since the problem of quantifying the water storage in small watersheds is never solved in the prior art, this concept is not really considered to be introduced into the field of prevention and control of debris flow disaster in the prior art. According to the present invention, the value of the dynamic changes in water quantity of small watersheds in the prevention and control of debris flow disaster in small watersheds is enhanced by solving the problems of the calculation of a real-time water storage model in a target watershed and the measurement of evaluation thresholds that match the water storage model. Accordingly, the disaster reduction scheme for debris flows in a small watershed provided in the present invention is able to break through the level of empirical summarization and becomes a scientifically measured technical scheme. The disaster reduction method using a drainage channel for regulation provided in the present invention can provide a basis for the simulation study of mathematical models for disaster reduction in small watersheds.

### BRIEF DESCRIPTION OF THE DRAWINGS

FIG. 1 is a schematic diagram of hydrometeorological monitoring in a small watershed.

FIG. 2 is a schematic diagram of a method for calculating water storage corresponding to a debris flow outbreak.

FIG. 3 shows the changes in the water storage in the watershed and the classification of early warning levels.

FIG. 4 is a schematic diagram of a channel-regulated disaster reduction scheme for debris flows in the small watershed.

FIG. 5 is a schematic diagram of the design structure of a drainage channel.

FIG. 6 shows the drainage channel-regulated changes in the water storage in the small watershed.

Reference numerals in Figures are:
001 watershed divide, 002 measurement of runoff at gully of watershed, 003 measurement of rainfall in watershed, 004 measurement of evaporation in watershed, 005 runoff on watershed slope, 006 confluence and runoff from channel, 007 loose deposits in watershed channel, 008 lateral water exchange of watershed, 009 small target watershed, and 010 drainage channel.

### DETAILED DESCRIPTION

Preferred embodiments of the present invention are further described below in conjunction with the accompanying drawings.

### Embodiment One

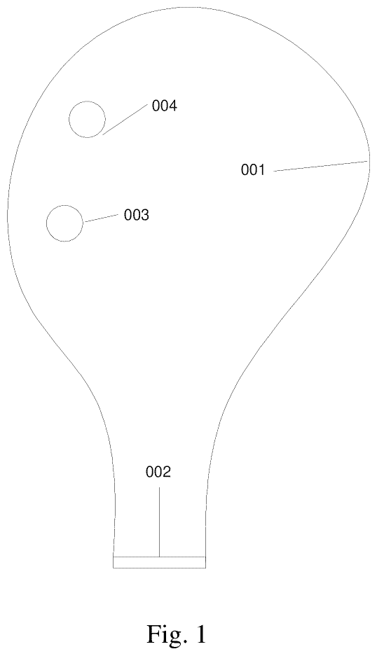

As shown in FIGS. 1 to 3, the method of the present invention is used to monitor and early warn the risk of debris flow disaster in a certain small watershed.

A small watershed in a study area is located in Fenghua City, Zhejiang Province. The whole watershed has a trumpet shape with good catchment conditions, which facilitates runoff from slopes into gullies. The average annual rainfall in the study area is close to 1500 mm, of which the rainfall from May to October can be up to two-thirds of the total annual rainfall due to the influence of typhoons. The vegetation in the study area is good, but a large amount of project debris was dumped directly into the gully on the lower slope of the highway bed due to the construction of Provincial Highway 33, resulting in the formation of a large amount of loose deposits in the main channel. Under typhoon and heavy rainfall, debris flows are highly likely to form.

### 1. Monitoring of Field Survey of a Target Watershed

The field survey of a target watershed is monitored to acquire basic data of the target watershed, the basic data including topographic and hydrological data used to build a hydrological model. Monitoring devices are deployed to collect real-time environmental monitoring data, the environmental monitoring data including evaporation, rainfall, and runoff data. The basic data are shown in Table 1.

TABLE 1
Basic Data of Small Target Watershed (Topographic Characteristic Parameters)

| | | | | Average | | | |
|---|---|---|---|---|---|---|---|
| | Average | | | Particle | | Average | |
| | Inclination | | | Size of | Vegetation | Specific | |
| Area of | of | | Bottom | Trench | Evaporation | Yield of | |
| Small | Slopes in | Inclination | Width | Bed | Factor of | Aquifer in | Slope |
| Watershed | Small | of Main | of Main | Debris | Small | Small | of Main |
| A | Watershed | Channel | Channel | M | Watershed | Watershed | Channel |
| (km²) | i (°) | η (°) | b (m) | (mm) | Ψ | β | θ(°) |
| 2.67 | 39.5 | 28.2 | 5.5 | 3.1 | 1.21 | 0.075 | |

The hydrological monitoring setup as shown in FIG. 1 is provided in the target watershed, environmental monitoring data (rainfall, evaporation and runoff data) for a total of one hydrological year from a certain day T1 to a certain day T2 are obtained according to hydrological monitoring of a long time series, and hydrological data for the basic data of the small target watershed are formed.

FIG. 1 is a schematic diagram of hydrometeorological monitoring in a small watershed, where 001 is a watershed divide, 002 indicates the measurement of runoff at a gully of the watershed, 003 indicates the measurement of rainfall in the watershed, and 004 indicates the measurement of evaporation in the watershed.

### 2. Construction of a Water Storage S Model of the Target Watershed

A GR4J hydrological model of the target watershed is constructed, and a water storage S model of the target watershed that is expressed by Equation 1 is further constructed using the GR4J hydrological model. In this implementation, the GR4J hydrological model adopts an improved GR4J hydrological model of the present invention. Model parameter calibration is performed, and the calculation result is shown in Table 2.

TABLE 2
Parameters of Water Storage S Model of Small Watershed

| | | | Time Base for |
|---|---|---|---|
| Water Storage | Groundwater | Groundwater Capacity | Hydrological Process |
| Capacity | Exchange Coefficient | on Previous Day | Line |
| (W1, mm) | (W2, mm) | (W3, mm) | (W4, d) |
| 220.92 mm | 1.04 mm | 20.05 mm | 1.85 d |

### 3. Acquisition of Initial Water Storage Sᵢₙₜ in the Watershed

Based on the parameters of the model, data are updated according to the hydrological monitoring for the whole day of the next day of T2, and an update value for the initial water storage in the watershed on that day is calculated. The parameter calculation process is shown in Table 3.

TABLE 3
Parameter Calculation Process for Initial Water Storage
in Watershed (Started on the Next Day of T2)

| Parameter | | Numerical Value | |
|---|---|---|---|
| Intermediate | Water Storage S₁ of Runoff Producing Reservoir | 119.24 | mm |
| Data for | on the Previous Day | | |
| Calculation | Precipitation Data Y on That Day | 25.6 | mm |
| of Initial | Evaporation Data Z on That Day | 1.25 | mm |
| Water | Effective Precipitation Yₙ on That Day | 24.35 | mm |
| Storage Sᵢₙₜ | Remaining Evaporation Capacity Zₙ on That Day | 0 | mm |
| in Small | Precipitation Yₛ for Replenishment of Runoff | 18.4 | mm |
| Watershed | Producing Reservoir on That Day | | |
| | Evapotranspiration Zₛ of Runoff Producing | 0.28 | mm |
| | Reservoir on That Day | | |
| | Update Value of Water Storage S′₁ of Runoff | 137.36 | mm |
| | Producing Reservoir on That Day | | |
| | Runoff Yield C_{L} of Runoff Producing Reservoir | 10.61 | mm |
| | on That Day | | |
| | Updated Total Runoff Yield Pᵣ on That Day | 16.56 | mm |
| | Water Qₛₖ Entering Confluence Reservoir on That | 14.00 | mm |
| | Day | | |
| | Water Q_{ck} Collected Directly to Outlet Section of | 1.47 | mm |
| | Watershed on That Day | | |
| | Water S₂ in Confluence Reservoir on the Previous | 32.39 | mm |
| | Day | | |
| | Water Exchange f for Period of That Day | 5.57 | mm |
| | Intermediate Amount R of Water Storage of | 40.82 | mm |
| | Confluence Reservoir on That Day | | |
| | Outflow Qᵣ from Confluence Reservoir on That | 0.36 | m³/s |
| | Day | | |
| | Update Value S′₂ of Water Storage of | 41.33 | mm |
| | Confluence Reservoir on That Day | | |
| | Outflow Q_{d} Collected to Outlet Section of | 7.04 | mm |
| | Watershed on That Day | | |
| Small | Update Value S of Water Storage in Watershed | 178.69 | mm |
| Watershed | on That Day | | |
| Sᵢₙₜ | | | |

### 4. Measurement of the Maximum Water Storage Sₘₐₓ for Runoff-Induced Debris Flows in the Target Watershed

At the beginning of the calculation, there is initial water storage Sᵢₙₜ in a small watershed. When a rainfall occurs, by calculating the effective rainfall in the watershed excluding evapotranspiration, it is considered that the rainfall leads to an increase in the soil moisture content of the watershed, the water table of the watershed rises, and then slope runoff and groundwater recharge channel runoff are formed in a debris flow formation area. Runoff H is formed in a flowing area of debris flows, and dynamic calculation (Equation 1-2) for water storage in the watershed can be carried out based on the rainfall Y, evaporation Z and runoff H in the process. Based on this hydrodynamic debris flow disaster formation mechanism, the critical water storage Sₘₐₓ in the watershed is calculated in real time by taking the minimum debris flow initiation critical flow L of the main channel as a benchmark.

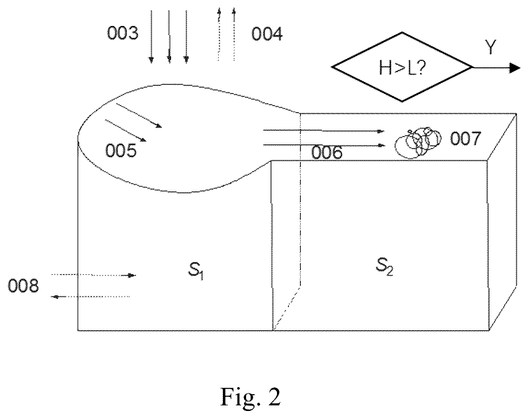

FIG. 2 is a schematic diagram of a method for calculating water storage corresponding to a debris flow outbreak, where 003 indicates the measurement of rainfall in the watershed, 004 indicates the measurement of evaporation in the watershed, 005 indicates the runoff on watershed slopes, 006 indicates the confluence and runoff from channels, 007 indicates loose deposits in watershed channels, and 008 indicates the lateral water exchange of the watershed.

According to Equation 2 and Equation 3, it is calculated in this embodiment that L=1.345 m³/s, and Sₘₐₓ=173.16 mm.

### 5. Early Warning According to a Value K

An early warning value K for debris flows in a small watershed is measured according to Equation 4, and debris flow early warning content in the target watershed is evaluated according to the value K.

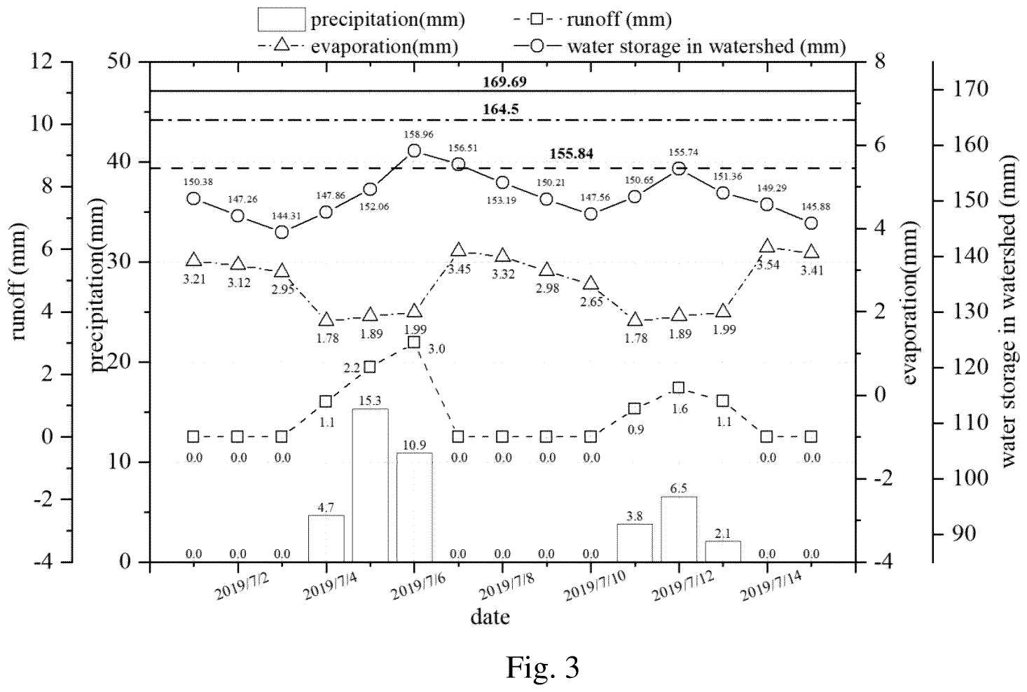

Hydrological monitoring data and the value of water storage in the small watershed during the half-month period from a certain day T3 to a certain day T4 are calculated, and the classification of early warning levels is carried out. FIG. 3 shows the changes in the water storage in the watershed and the classification of early warning levels. As shown in FIG. 3, the water storage in the watershed regarding a red early warning is 169.69 mm, the water storage in the watershed regarding an orange early warning is 164.50 mm, and the water storage in the watershed regarding a blue early warning is 155.84 mm.

### Embodiment Two

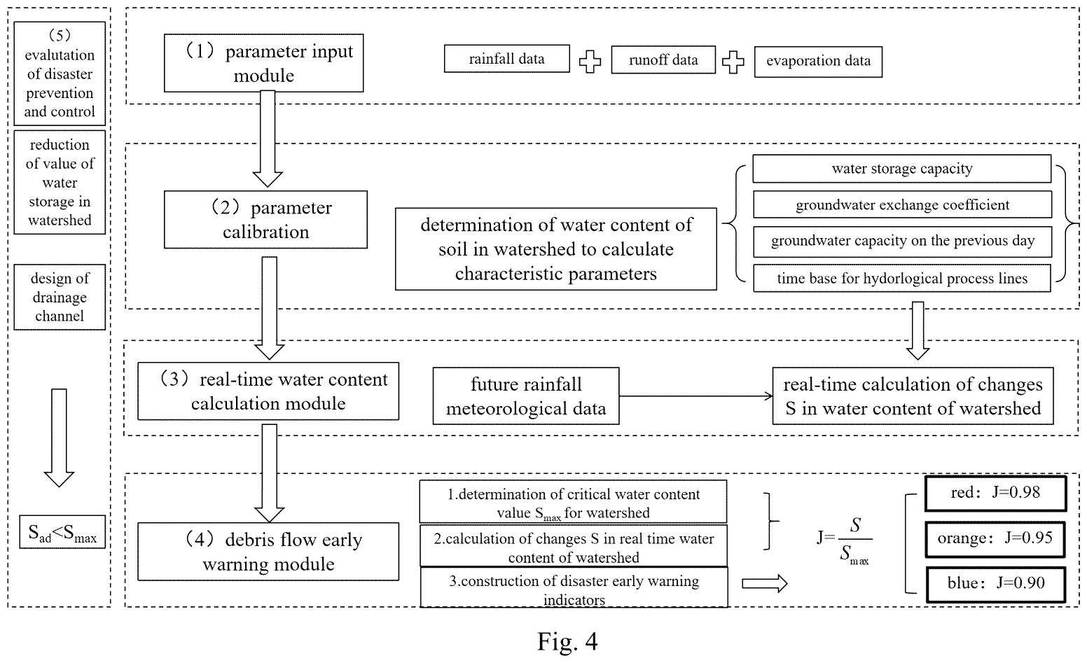

As shown in FIGS. 4-6, based on a monitoring and early warning scheme for a small watershed in the embodiment, a channel-regulated disaster reduction scheme is designed using the method of the present invention.

FIG. 4 is a schematic diagram of a channel-regulated disaster reduction scheme for debris flows in the small watershed.

### 1. Design of a Drainage Channel

An inlet of the drainage channel is arranged in the area, where loose deposits are concentrated, upstream of the main channel for debris flows in the small watershed in the embodiment, and an outlet is arranged away from the area where loose deposits are distributed.

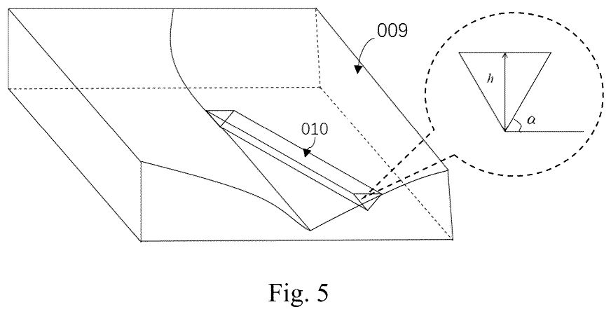

The drainage channel is V-bottomed and the main structural parameters are shown in Table 4. FIG. 5 is a schematic diagram of the design structure of a drainage channel, where 009 is the small target watershed, and 010 is the drainage channel.

TABLE 4
Main Structural Parameters of Drainage Channel

| Hydraulic Gradient | Inclination of Triangular Cross-Section | Roughness Coefficient |
|---|---|---|
| J(%) | α(°) | n |
| 0.57 | 30° | 0.015 |

### 2. Measurement of Drainage Channel-Regulated Disaster Reduction Capacity

A diverting time T of the drainage channel is set, a real-time water level elevation h(t) in the drainage channel is collected, the real-time diversion of water Q(t) of the drainage channel and the drainage channel-regulated real-time water storage S(t), i.e. S_{ad}(t), in the small watershed are measured according to Equation 7 and Equation 8, and then the drainage channel-regulated value K is calculated according to Equation 9.

$$K = {S}_{ad} ( t ) / {S}_{max} \qquad Equation 9$$

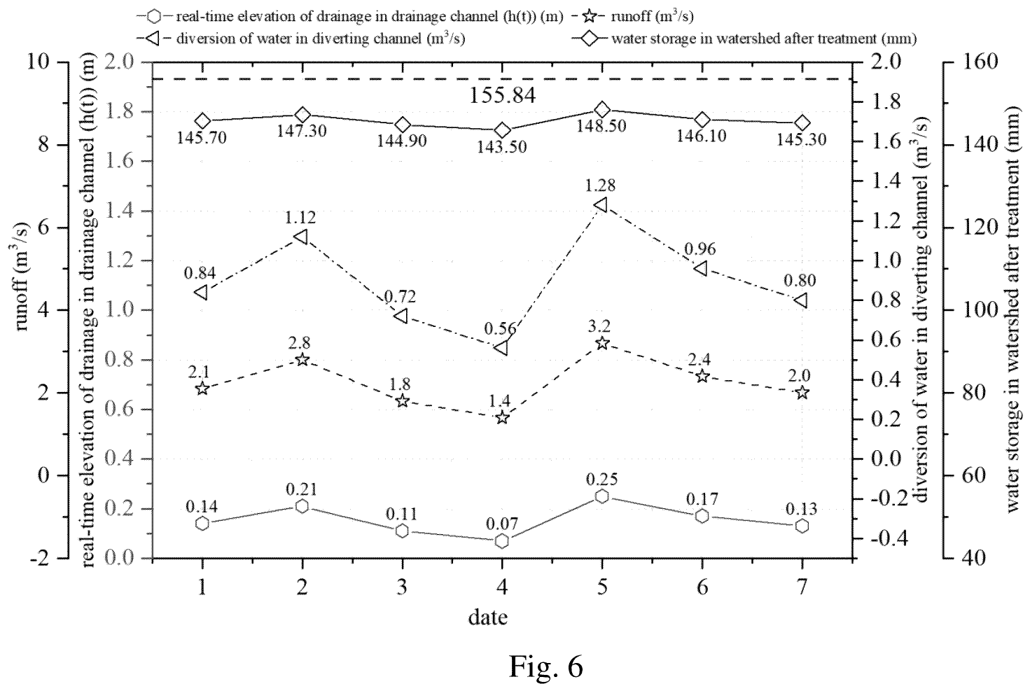

During the set period T, the rainfall in the small watershed is high, the water storage S in the small watershed is greater than 155.84 mm, and the value K of the watershed reaches the interval of blue early warning. After regulated by the drainage channel, S_{ad}(t) is reduced to 90% of the original S, and the risk of debris flow disaster in the small watershed is out of the interval of blue early warning, with the results shown in Table 5. FIG. 6 shows the drainage channel-regulated changes in the water storage in the small watershed.

TABLE 5
Drainage Channel-Regulated Disaster Reduction Capacity

| | | | Drainage Channel- | |
|---|---|---|---|---|
| Diverting | Real-Time | Real-Time | Regulated Real- | |
| Time of | Water Level | Diversion of Water | Time Water | |
| Drainage | Elevation in | of Drainage | Storage in Small | |
| Channel | Channel | Channel | Watershed | Drainage Channel- |
| T | h(t)(m) | Q(t) | S_{ad}(t) | Regulated Value K |
| Certain Day | See FIG. 6 | See FIG. 6 | See FIG. 6 | <0.9K |
| T4 to | | | | |
| Certain Day | | | | |
| T5 | | | | |

In this implementation, reasonable structural parameters for the drainage channel can be calculated inversely if the drainage channel-regulated value K being less than 90% of the value K before the regulation is taken as the disaster reduction design objective for debris flows. For example, the inclination of a triangular cross-section can be designed and calculated as α=30°.

What is claimed is:

1. An early warning method for debris flow disaster in a small watershed, characterized in:
step S100, monitoring field survey of a target watershed to acquire basic data of the target watershed, the basic data including topographic and hydrological data used to build a hydrological model; and deploying monitoring devices to collect real-time environmental monitoring data, the environmental monitoring data including evaporation, rainfall, and runoff data;
step S200, constructing a GR4J hydrological model of the target watershed using the basic data of the target watershed, and constructing, using the GR4J hydrological model, a water storage S model of the target watershed that is expressed by Equation 1-1,
$$S = {S}_{1} + {S}_{2} \qquad Equation 1 - 1$$
in the Equation, S₁ and S₂ are the water storage of a runoff producing reservoir and the water storage of a confluence reservoir in the GR4J hydrological model, respectively, in mm;
step S300, based on the real-time environmental monitoring data, acquiring initial water storage Sᵢₙₜ in the target watershed using the water storage S model;
step S400, measuring the maximum water storage Sₘₐₓ for runoff-induced debris flows in the target watershed using the water storage S model of the target watershed,
$${S}_{max} = {S}_{int} + Y - Z - L + {R}_{io} \qquad Equation 2$$
$$L = 4. {bM}^{1.5} / tan {θ}^{1.17} \qquad Equation 3$$
in the Equations, Sₘₐₓ is the maximum water storage for runoff-induced debris flows in the target watershed,
Sᵢₙₜ is the initial water storage in the target watershed in mm, determined in step S300,
Y is the precipitation over the watershed in the GR4J hydrological model,
Z is the evaporation over the watershed in the GR4J hydrological model,
Rᵢₒ is the water exchange between groundwater and the watershed in the GR4J hydrological model,
L is the minimum debris flow initiation critical flow in a main channel of the target watershed, in m³/s,
b is the width of the main channel of the target watershed, in m, determined according to the basis data,
M is the average particle size of trench bed debris, in mm, determined according to the basis data, and
θ is the slope of the main channel of the target watershed, in °, determined according to the basis data;
step S500, measuring dynamic update values S′₁ and S′₂ of S₁ and S₂, as well as real-time water storage S(t) in the target watershed by taking rainfall data as an input to the water storage S model,
$$S ( t ) = {S}_{1}^{′} + {S}_{2}^{′} \qquad Equation 1 - 2$$
step S600, measuring a debris flow early warning value K for the target watershed, and evaluating debris flow early warning content in the target watershed according to the value K,
$$K = S ( t ) / {S}_{max} \qquad Equation 4$$
in the Equation, K is the debris flow early warning value for the target watershed.

2. The early warning method according to claim 1, characterized in that the GR4J hydrological model is an improved GR4J hydrological model, and the dynamic update values S′₁ and S′₂ of S₁ and S₂ are measured respectively according to Equation 5-1 and Equation 5-2,
$${S}_{1}^{′} = ( {S}_{1} - {Z}_{s} + {Y}_{s} ) A β tan i \qquad Equation 5 - 1$$
$${S}_{2}^{′} = ( {S}_{2} - R ) A tan η \qquad Equation 5 - 2$$
in the Equations, Zₛ is the evapotranspiration of the runoff producing reservoir in the GR4J hydrological model,
Yₛ is the precipitation for replenishment of the runoff producing reservoir in the GR4J hydrological model,
A is the area of the target watershed, in m², determined according to the basis data,
i is the average inclination of slopes in the target watershed, in °, determined according to the basis data;
β is the average specific yield of the aquifer in the target watershed, determined according to the basis data,
R is the intermediate amount of the water storage of the confluence reservoir in the GR4J hydrological model, and
η is the inclination of the main channel of the target watershed, in °, determined according to the basis data of the target watershed.

3. The early warning method according to claim 2, characterized in that the GR4J hydrological model is an improved GR4J hydrological model, and the evapotranspiration Zₛ of the runoff producing reservoir in the model is expressed by Equation 6,
$${Z}_{s} = \frac{{S}_{1} ( 2 - \frac{{S}_{1}}{{w}_{1}} ) tanh ( \frac{{Z}_{n}}{{w}_{1}} )}{1 + ( 1 - \frac{{S}_{1}}{{w}_{1}} ) tanh ( \frac{{Z}_{n}}{{w}_{1}} )} ψ \qquad Equation 6$$
in the Equation, w₁ is the water storage of the runoff producing reservoir in the GR4J hydrological model, in mm,
Zₙ is the residual evapotranspiration capacity in the GR4J hydrological model, in mm, and
ψ is a vegetation evaporation factor of the target watershed, determined according to the basis data.

4. The early warning method according to claim 3, characterized in that in the step S400, the basic data of the target watershed is substituted into the water storage S model to measure the initial water storage Sᵢₙₜ in the target watershed.

5. The early warning method according to claim 3, characterized in that in the step S400, Sᵢₙₜ is the water storage in the watershed that is obtained by training the GR4J model with time-series monitoring data.

6. The early warning method according to claim 1, characterized in that in the step S500, the rainfall data input into the water storage S model are forecast rainfall data or real-time monitoring watershed hydrological update data.

7. The early warning method according to claim 6, characterized in that in the step S600, K≥0.98 indicates a red early warning, 0.98>K≥0.95 indicates an orange early warning, and 0.95>K≥0.90 indicates a blue early warning.

8. A disaster reduction method for debris flows in a small watershed, which is implemented using the early warning method for debris flow disaster in a small watershed according to claim 6, characterized in: adding an artificial drainage measure in a target watershed, diverting the runoff in the target watershed by using the artificial drainage measure, accelerating the release of the water storage in the target watershed, acquiring S(t) for regulation of a drainage channel according to Equation 7, and not performing step S600 after step S500,
$${S}_{ad} ( t ) = S ( t ) - T Q ( t ) / A \qquad Equation 7$$
in the Equation, S_{ad}(t) is S(t) for regulation of the artificial drainage measure, in mm,
Q(t) is the real-time diversion of water of the artificial drainage measure, in m³/s,
A is the area of the target watershed, in m², determined according to the basis data, and
T is the diverting time of the artificial drainage measure, in s, determined according to monitoring data.

9. The early warning method according to claim 8, characterized in that the artificial drainage measure is to construct a drainage channel with a V-shaped bottom, an inlet of the drainage channel is arranged in the area, where loose deposits are concentrated, upstream of the main channel of the target watershed, and an outlet is arranged away from the area where loose deposits are distributed; Q(t) is the real-time diversion of water of the drainage channel, and is measured according to Equation 8,
$$Q ( t ) = {{\frac{1}{n} [ \frac{h ( t )}{tan α} ]}^{5 / 3} [ \frac{2 h ( t )}{sin α} ]}^{- 2 / 3} {J}^{1 / 2} \qquad Equation 8$$
in the Equation, n is a roughness coefficient of the drainage channel, determined according to structural parameters of the drainage channel,
J is the hydraulic gradient of the drainage channel, in %, determined according to structural parameters of the drainage channel,
h(t) is a real-time water level elevation in the drainage channel, in m, collected by a monitoring device in real time, and
α is the inclination of a triangular cross-section of the drainage channel, in °, determined according to structural parameters of the drainage channel.

10. The early warning method according to claim 9, characterized in that a structural parameter α or n or J of the drainage channel is calculated according to inversion of a debris flow disaster reduction design objective, which is a relationship between S_{ad}(t) and S(t), or a relationship between values K respectively expressed by S_{ad}(t) and S(t).
